(19) United States
(12) Patent Application Publication
(10) Pub. No.: US 2002/0145233 A1
(43) Pub. Date: Oct. 10, 2002

(54) Method for manufacturing fire-proof material

(76) Inventor: Ching-Cheng Lai, Dou-Liou City (TW)

Correspondence Address: Hart, Baxley, Daniels & Holton, Fifth Floor, 59 John Street, New York, NY, 10038, US

(21) Appl. No.: 09/828,516

(22) Filed: Apr. 9, 2001

(51) Int. Cl. C08J 5/04

(52) U.S. Cl. 264/331.19

(57) ABSTRACT

A method for manufacturing fire-proof material includes step 1 of mixing melamine, plant fiber powder such as ground barns, sugar canes, coconut shells, corn starch or wood pieces, and fire-proof agent; step 2 of molding the mixture in step 1 in molds and applying pressure at a certain temperature, and step 3 of removing the molds to have the fire-proof material with desired shapes.

### FIELD OF THE INVENTION

The present invention relates to a method for manufacturing fire-proof material and comprising a step of mixing melamine resin and plant fiber powder and a step of molding the material into desired shapes.

### BACKGROUND OF THE INVENTION

Most of conventional fire-proof board are made to be flat boards and focus on the assembly of the fire-proof boards and conventional boards. In particular, the fire-proof boards and the conventional boards are alternatively overlapped with each other to form a multi-layer board which is used to be a wall for separating rooms. In other words, the existed fire-proof boards cannot meet the requirements in the market and most of fire cases begin at the interior of the houses. Nevertheless, such fire-proof boards are difficult to be shaped to a desired shape, such computer casings, communication parts, or interior design decorations. Therefore, it is important to have the fire-proof material be easily formed into desired shapes.

The present invention intends to provide a method that combines plant fiber powder, melamine and fire-proof agent.

### SUMMARY OF THE INVENTION

In accordance with one aspect of the present invention, there is provided a method for manufacturing fire-proof material and includes step 1 of mixing melamine, plant fiber powder and fire-proof agent; step 2 of molding the mixture in step 1 in molds and applying pressure at a certain temperature, and step 3 of removing the molds to have the fire-proof material with desired shapes.

The primary object of the present invention is to provide a method for manufacturing fire-proof material that can be easily shaped.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a flow chart of the method of the present invention.

### DETAILED DESCRIPTION OF THE PREFERRED EMBODIMENT

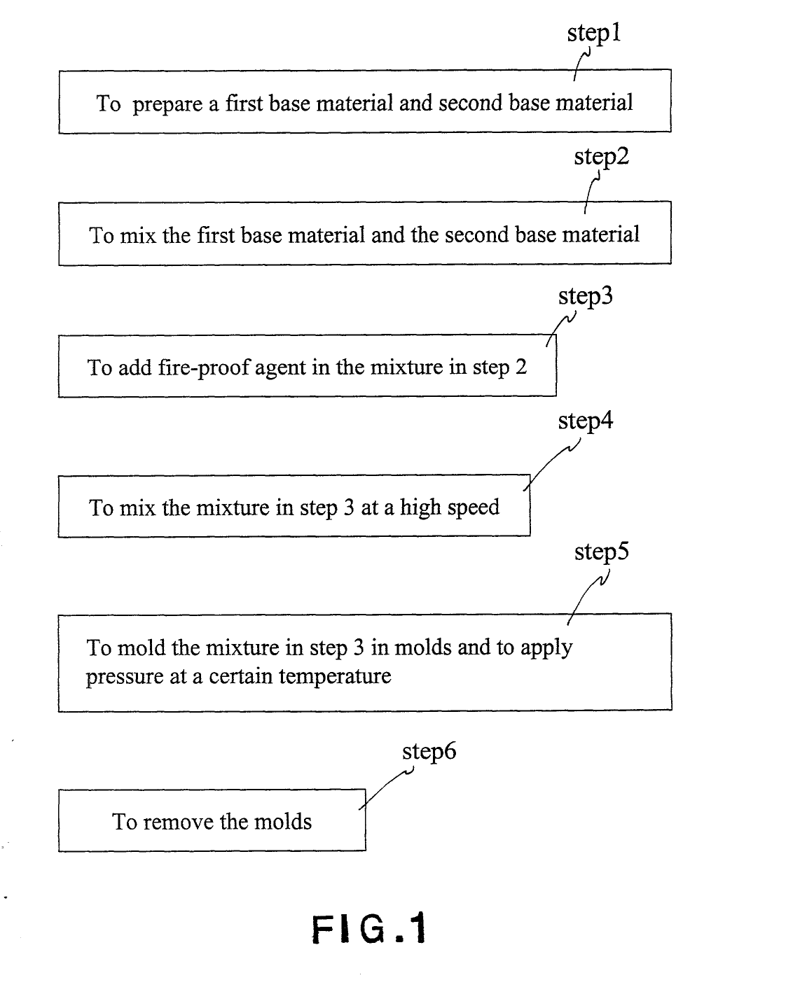

Referring to FIG. 1, the method for manufacturing fire-proof material of the present invention comprises the following steps:

step 1: to prepare a first base material which is melamine, and a second base material which is plant fiber powder;

step 2: to mix the first base material and the second base material;

step 3: to add fire-proof agent such as antimony Trioxide and Calcium Carbonate in the mixture in step 2;

step 4: to mix the mixture in step 3 at a high speed;

step 5: to mold the mixture in step 3 in molds and to apply pressure at a certain temperature, and

step 6: to remove the molds.

The mixture in step 3 includes 45% of the first base material and 45% of the second base material. The plant fiber powder may come from ground barns, ground sugar canes, ground coconut shells, corn starch or ground wood pieces. In order to let the fire-proof material to have color, desired pigment can be added and mixed with the mixture in step 3.

The material can be easily molded to have desired shapes so as to be used in wide variety of fields and the cost for obtaining the two types of base material is so low that the fire-proof material of the present invention is provided in the market at lower price.

While we have shown and described a preferred embodiment in accordance with the present invention, it should be clear to those skilled in the art that further embodiments may be made without departing from the scope of the present invention.

What is claimed is:

1. A method for manufacturing fire-proof material comprising the following steps:
step 1: to mix melamine, plant fiber powder and fire-proof agent;
step 2: to mold the mixture in step 1 in molds and to apply pressure at a certain temperature, and
step 3: to remove the molds.

2. The method as claimed in claim 1 wherein the mixture in step 1 includes 45% of the melamine and 45% of the plant fiber powder.

3. The method as claimed in claim 1, wherein the plant fiber powder includes ground barns.

4. The method as claimed in claim 1, wherein the plant fiber powder includes ground sugar canes.

5. The method as claimed in claim 1, wherein the plant fiber powder includes ground coconut shells.

6. The method as claimed in claim 1, wherein the plant fiber powder includes corn starch.

7. The method as claimed in claim 1, wherein the plant fiber powder includes ground wood pieces.

8. The method as claimed in claim 1, wherein the fire-proof agent includes antimony Trioxide and Calcium Carbonate.

9. The method as claimed in claim 1 further comprising a pigment mixed with the mixture in step 1.
